(19) United States
(12) Patent Application Publication
(10) Pub. No.: US 2015/0381641 A1
(43) Pub. Date: Dec. 31, 2015

(54) METHOD AND SYSTEM FOR EFFICIENT MANAGEMENT OF SECURITY THREATS IN A DISTRIBUTED COMPUTING ENVIRONMENT

(71) Applicant: Intuit Inc., Mountain View, CA (US)

(72) Inventors: Luis Felipe Cabrera, Bellevue, WA (US); M. Shannon Lietz, San Marcos, CA (US)

(73) Assignee: INTUIT INC., Mountain View, CA (US)

(21) Appl. No.: 14/319,352

(22) Filed: Jun. 30, 2014

(51) Int. Cl. H04L 29/06

(52) U.S. Cl. CPC H04L 63/1425

(57) ABSTRACT

A method and system for distributing security threat management of an instance of an application that is hosted from multiple geographic locations, according to one embodiment. The method and system include monitoring first operational characteristics of the instance of the application, and establishing an average for the first operational characteristics based at least partially on the first operational characteristics, according to one embodiment. The method and system include identifying a deviation from the average for the first operational characteristics that is more than a predetermined amount, according to one embodiment. The method and system include retrieving second operational characteristics for at least one other instance of the application and comparing the first operational characteristics to the second operational characteristics, according to one embodiment. The system and method include reporting an identification of a potential security threat, according to one embodiment.

### BACKGROUND

To provide improved web-based or cloud-based services, some developers prefer to host an application as physically or geographically close as possible to users of the application. Some cloud service providers satisfy this developer preference by allowing developers to select one or more geographical regions in which to host their applications. Regionally hosted versions of applications enable regional customization of content, enable more responsive services (e.g., less network latency), and enable easier compliance with regional, government, and/or geographic regulations that have been placed on online services. Because developers can now globally host multiple versions or instances of an application, monitoring all of the instances for security threats from a centralized computing system can place overwhelming demands on the network resources and other computing resources of the centralized computing system.

What is needed is a method and system for distributing security threat management of applications to reduce the effects of centralized security threat management.

### SUMMARY

In accordance with one embodiment, a method and system for distributing security threat management of an application that is hosted from multiple geographic locations includes monitoring, with a computing system, first operational characteristics of the first instance of the application, according to one embodiment. The first instance of the application is hosted by a first virtual asset in a first computing environment, and the first computing environment is located in a first geographic region, according to one embodiment. The first operational characteristics include a quantity of communication traffic between the first instance of the application and one or more external computing systems, according to one embodiment.

The method and system include establishing an average for the first operational characteristics based at least partially on the first operational characteristics and identifying a first deviation from the average for the first operational characteristics that is more than a first predetermined amount, according to one embodiment.

The method and system include retrieving second operational characteristics for at least one other instance of the application, in response to identifying the first deviation from the average, according to one embodiment. The at least one other instance of the application is hosted by one or more second virtual assets in one or more second computing environments, according to one embodiment. The one or more second computing environments are disposed in one or more second geographic regions that are different than the first geographic region, according to one embodiment.

The method and system include comparing the first operational characteristics to the second operational characteristics and reporting an identification of a potential security threat, if the first operational characteristics differ from the second operational characteristics by more than a second predetermined amount, according to one embodiment.

### BRIEF DESCRIPTION OF THE DRAWINGS

FIG. 1 is a block diagram of a hardware architecture for distributing security threat management of an application, in accordance with one embodiment.

FIG. 2 is a block diagram of an asset management computing environment, in accordance with one embodiment.

FIG. 3 is a block diagram of regional asset computing environments, in accordance with one embodiment.

FIG. 4 is a flow diagram for distributing security threat management of an application, in accordance with one embodiment.

Common reference numerals are used throughout the FIG.s and the detailed description to indicate like elements. One skilled in the art will readily recognize that the above FIG.s are examples and that other architectures, modes of operation, orders of operation, and elements/functions can be provided and implemented without departing from the characteristics and features of the invention, as set forth in the claims.

### DETAILED DESCRIPTION

Embodiments will now be discussed with reference to the accompanying FIG.s, which depict one or more exemplary embodiments. Embodiments may be implemented in many different forms and should not be construed as limited to the embodiments set forth herein, shown in the FIG.s, and/or described below. Rather, these exemplary embodiments are provided to allow a complete disclosure that conveys the principles of the invention, as set forth in the claims, to those of skill in the art.

The INTRODUCTORY SYSTEM, HARDWARE ARCHITECTURE, and PROCESS sections herein include systems and processes suitable for distributing security threat management for virtual assets hosted from multiple geographic locations, according to various embodiments.

Introductory System

Herein, the term “production environment” includes the various components, or assets, used to deploy, implement, access, and use, a given application as that application is intended to be used. In various embodiments, production environments include multiple assets that are combined, communicatively coupled, virtually and/or physically connected, and/or associated with one another, to provide the production environment implementing the application.

As specific illustrative examples, the assets making up a given production environment can include, but are not limited to, one or more computing environments used to implement the application in the production environment such as a data center, a cloud computing environment, a dedicated hosting environment, and/or one or more other computing environments in which one or more assets used by the application in the production environment are implemented; one or more computing systems or computing entities used to implement the application in the production environment; one or more virtual assets used to implement the application in the production environment; one or more supervisory or control systems, such as hypervisors, or other monitoring and management systems, used to monitor and control assets and/or components of the production environment; one or more communications channels for sending and receiving data used to implement the application in the production environment; one or more access control systems for limiting access to various components of the production environment, such as firewalls and gateways; one or more traffic and/or routing systems used to direct, control, and/or buffer, data traffic to components of the production environment, such as routers and switches; one or more communications endpoint proxy systems used to buffer, process, and/or direct data traffic, such as load balancers or buffers; one or more secure communication protocols and/or endpoints used to encrypt/decrypt data, such as Secure Sockets Layer (SSL) protocols, used to implement the application in the production environment; one or more databases used to store data in the production environment; one or more internal or external services used to implement the application in the production environment; one or more backend systems, such as backend servers or other hardware used to process data and implement the application in the production environment; one or more software systems used to implement the application in the production environment; and/or any other assets/components making up an actual production environment in which an application is deployed, implemented, accessed, and run, e.g., operated, as discussed herein, and/or as known in the art at the time of filing, and/or as developed after the time of filing.

As used herein, the terms “computing system”, “computing device”, and “computing entity”, include, but are not limited to, a virtual asset; a server computing system; a workstation; a desktop computing system; a mobile computing system, including, but not limited to, smart phones, portable devices, and/or devices worn or carried by a user; a database system or storage cluster; a switching system; a router; any hardware system; any communications system; any form of proxy system; a gateway system; a firewall system; a load balancing system; or any device, subsystem, or mechanism that includes components that can execute all, or part, of any one of the processes and/or operations as described herein.

In addition, as used herein, the terms computing system and computing entity, can denote, but are not limited to, systems made up of multiple: virtual assets; server computing systems; workstations; desktop computing systems; mobile computing systems; database systems or storage clusters; switching systems; routers; hardware systems; communications systems; proxy systems; gateway systems; firewall systems; load balancing systems; or any devices that can be used to perform the processes and/or operations as described herein.

As used herein, the term “computing environment” includes, but is not limited to, a logical or physical grouping of connected or networked computing systems and/or virtual assets using the same infrastructure and systems such as, but not limited to, hardware systems, software systems, and networking/communications systems. Typically, computing environments are either known environments, e.g., “trusted” environments, or unknown, e.g., “untrusted” environments. Typically, trusted computing environments are those where the assets, infrastructure, communication and networking systems, and security systems associated with the computing systems and/or virtual assets making up the trusted computing environment, are either under the control of, or known to, a party. Examples of trusted computing environments include the assets and components making up data centers associated with, and/or controlled by, an application and/or any computing systems and/or virtual assets, and/or networks of computing systems and/or virtual assets, associated with, known by, and/or controlled by, an application.

In contrast, unknown, or untrusted computing environments are environments and systems where the assets, components, infrastructure, communication and networking systems, and security systems implemented and associated with the computing systems and/or virtual assets making up the untrusted computing environment, are not under the control of, and/or are not known by, a party, and/or are dynamically configured with new elements capable of being added that are unknown to the party. Examples of untrusted computing environments include, but are not limited to, public networks, such as the Internet, various cloud-based computing environments, and various other forms of distributed computing systems.

In various embodiments, each computing environment includes allocated assets and virtual assets associated with, and controlled or used to create, and/or deploy, and/or operate an application.

It is often the case that to create, and/or deploy, and/or operate, application data must be transferred between a first computing environment that is an untrusted computing environment and a trusted computing environment. However, in other situations a party may wish to transfer data between two trusted computing environments, and/or two untrusted computing environments.

In various embodiments, one or more cloud computing environments are used to create, and/or deploy, and/or operate an application that can be any form of cloud computing environment, such as, but not limited to, a public cloud; a private cloud; a virtual private network (VPN); a subnet; a Virtual Private Cloud (VPC); a sub-net or any security/communications grouping; or any other cloud-based infrastructure, sub-structure, or architecture, as discussed herein, and/or as known in the art at the time of filing, and/or as developed after the time of filing.

In many cases, a given application or service may utilize, and interface with, multiple cloud computing environments, such as multiple VPCs, in the course of being created, and/or deployed, and/or operated.

As used herein, the term “virtual asset” includes any virtualized entity or resource, and/or virtualized part of an actual, or “bare metal” entity. In various embodiments, the virtual assets can be, but are not limited to, virtual machines, virtual servers, and instances implemented in a cloud computing environment; databases associated with a cloud computing environment, and/or implemented in a cloud computing environment; services associated with, and/or delivered through, a cloud computing environment; communications systems used with, part of, or provided through, a cloud computing environment; and/or any other virtualized assets and/or sub-systems of “bare metal” physical devices such as mobile devices, remote sensors, laptops, desktops, point-of-sale devices, ATMs, electronic voting machines, etc., located within a data center, within a cloud computing environment, and/or any other physical or logical location, as discussed herein, and/or as known/available in the art at the time of filing, and/or as developed/made available after the time of filing.

In various embodiments, any, or all, of the assets making up a given production environment discussed herein, and/or as known in the art at the time of filing, and/or as developed after the time of filing, can be implemented as virtual assets.

Typically, virtual assets are created, or instantiated, using steps, instructions, processes, code, or “recipes” referred to herein as “virtual asset creation templates.” Typically, virtual assets that have the same, or similar, operational parameters are created using the same or similar “virtual asset creation templates.”

Examples of virtual asset creation templates include, but are not limited to, any tool and/or system for creating and managing a collection of related cloud resources. Illustrative examples of such a virtual asset creation template are any of the cloud formation templates/tools provided by Amazon Web Service (AWS), Rack Space, Joyent, and/or any other of the numerous cloud based infrastructure providers.

Other examples of virtual asset creation templates include, but are not limited to, any configuration management tool associated with, and/or used to create, virtual assets. One specific illustrative example of such a virtual asset creation template is a cookbook or recipe tool such as a Chef Recipe or system or any other fundamental element, or set of elements, used to override the default settings on a node within an infrastructure or architecture.

Other examples of virtual asset creation templates include, but are not limited to, any virtual appliance used to instantiate virtual assets. One specific illustrative example of such a virtual asset creation template is an Amazon Machine Image (AMI), and/or similar functionality provided by Amazon Web Service (AWS), Rack Space, Joyent, and/or any other of the numerous cloud based infrastructure providers.

Other examples of virtual asset creation templates include, but are not limited to, any appliance, or tool, or system, or framework, used to instantiate virtual assets as discussed herein, and/or as known/available in the art at the time of filing, and/or as developed/made available after the time of filing.

Herein virtual assets that have the same, or similar, operational parameters and are created by the same or similar virtual asset creation template are generically referred to as virtual assets of the same “class.” Examples of virtual asset classes include, but are not limited to, virtual machine classes; virtual server classes; virtual database or data store classes; self-monitoring virtual assets including specific types of instances instantiated in a cloud environment; application development process classes; and application classes.

In one embodiment, two or more assets, such as computing systems and/or virtual assets, and/or two or more computing environments, are connected by one or more communications channels including but not limited to, Secure Sockets Layer communications channels and various other secure communications channels, and/or distributed computing system networks, such as, but not limited to: a public cloud; a private cloud; a virtual private network (VPN); a subnet; any general network, communications network, or general network/communications network system; a combination of different network types; a public network; a private network; a satellite network; a cable network; or any other network capable of allowing communication between two or more assets, computing systems, and/or virtual assets, as discussed herein, and/or available or known at the time of filing, and/or as developed after the time of filing.

As used herein, the term “network” includes, but is not limited to, any network or network system such as, but not limited to, a peer-to-peer network, a hybrid peer-to-peer network, a Local Area Network (LAN), a Wide Area Network (WAN), a public network, such as the Internet, a private network, a cellular network, any general network, communications network, or general network/communications network system; a wireless network; a wired network; a wireless and wired combination network; a satellite network; a cable network; any combination of different network types; or any other system capable of allowing communication between two or more assets, virtual assets, and/or computing systems, whether available or known at the time of filing or as later developed.

As used herein, the term “user” includes, but is not limited to, any party, parties, entity, and/or entities using, or otherwise interacting with any of the methods or systems discussed herein. For instance, in various embodiments, a user can be, but is not limited to, a person, a commercial entity, an application, a service, and/or a computing system.

As used herein, the term “tenant” includes, but is not limited to, any user that enters a relationship, agreement, and/or contract, with an asset service provider or other service provider to receive an allocation of one or more assets or asset resources within an asset computing environment. In some embodiments, the terms “tenant” and “tenant computing environment” are interchangeably used even though, in some cases, a tenant represents a party, parties, or entities while the tenant computing environment represents one or more computing resources that are used by or that are at least partially under the control of the tenant.

Hardware Architecture

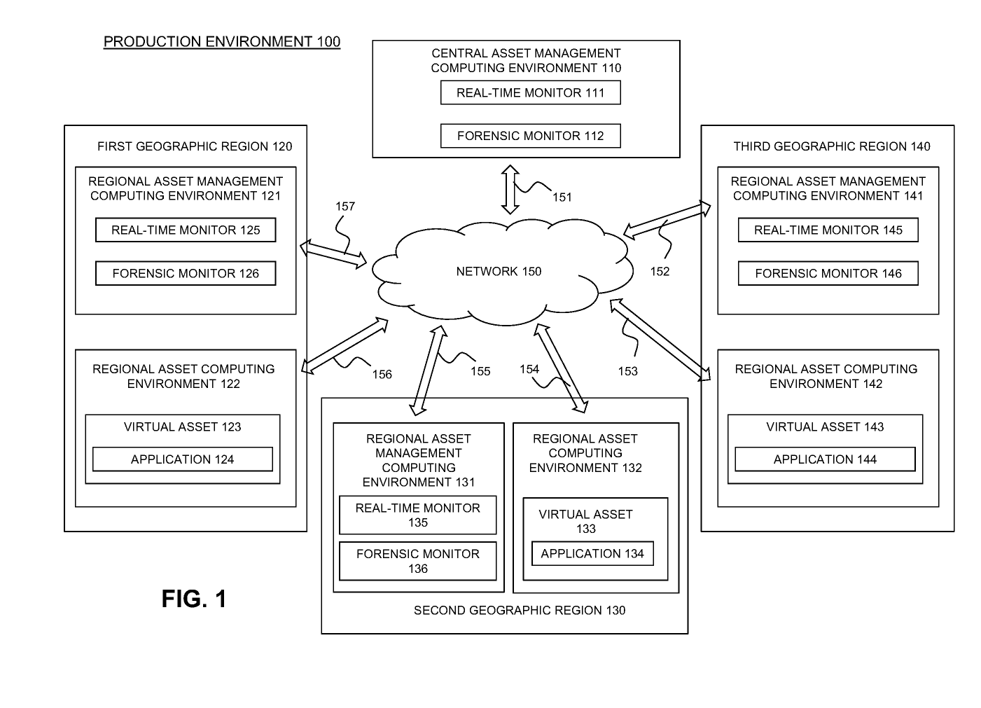

FIG. 1 illustrates a block diagram of a production environment 100 for distributing security threat management of an application that is hosted from multiple geographic locations. A virtual asset can be configured to host a single instance of an application in a particular geographic location and be configured to monitor operational characteristics (e.g., communications traffic content, received commands, and traffic quantity) of the application, to detect potential security threats that may be at least partially based on the operational characteristics of the application. One technical challenge or problem that may arise from monitoring the operational characteristics of a single instance of an application in a single geographical location is that changes to the operational characteristics of the application can be mistaken for a potential security threat in the absence of multi-regional context. In other words, without understanding what is happening to other instances of an application in other geographical regions, it may be difficult to determine whether the operational characteristics of a single instance of the application are normal or are within historic tolerances.

According to one embodiment, a computing environment monitors multiple instances of an application, and at least some of the multiple instances of the application are hosted by virtual assets that are located in different geographic locations, i.e., distributed by geographic location. By hosting multiple instances of an application in multiple geographic locations and by different virtual assets, a computing environment can monitor communications to every instance to enable multi-regional or global analysis of an application. Advantageously, multi-regional analysis of an application enables detection of regional symptoms or characteristics of potential security threats to the application. The regional symptoms or characteristics of potential security threats can be detected by comparing or correlating operational characteristics of an instance of the application in one region with the operational characteristics of other instances of the application being executed in one or more other regions.

One technical challenge or problem that may arise while monitoring the operational characteristics of multiple instances of an application hosted by virtual assets that are located in different geographic locations is that a centralized collections and analysis of all of the communications and other operational characteristics of the multiple instances can consume extensive quantities of computing resources. According to one embodiment, a centralized asset management computing environment selectively monitors operational characteristics of instances of the application using regionally distributed computing resources. For example, the centralized asset management computing environment causes one or more regional asset management computing environments to monitor operational characteristics of instances of the application that are hosted in regions that may be subject to higher risks of exposure to potential security threats, e.g., high traffic regions for the application or regions with computing environments having above-average exposure to potential or actual security threats, according to one embodiment.

The production environment 100 includes computing environments for distributing and/or decentralizing security threat management of virtual assets that are operated from multiple geographic locations, according to one embodiment. The production environment 100 includes a central asset management computing environment 110, a first geographic region 120, a second geographic region 130, and a third geographic region 140 communicatively coupled to each other through a network 150, according to one embodiment. The first geographic region 120 includes a regional asset management computing environment 121 and a regional asset computing environment 122, the second geographic region 130 includes a regional asset management computing environment 131 and a regional asset computing environment 132, and the third geographic region 140 includes a regional asset management computing environment 141 and a regional asset computing environment 142, according to one embodiment. According to various embodiments, each of the computing environments of the production environment 100 can be generically referred to as a “first computing environment”, a “second computing environment”, a “third computing environment”, and so forth. The central asset management computing environment 110 communicates information between the first geographic region 120, the second geographic region 130, and the third geographic region 140 to monitor various operational characteristics of the regional asset computing environments 122, 132, 142 and to monitor various operational characteristics of the instances of the application hosted by respective ones of the regional asset computing environment 122, 132, 142, according to one embodiment.

The central asset management computing environment 110 coordinates the resources of geographically distributed computing environments to perform real-time analysis and/or forensic analysis of applications within the production environment 100. The central asset management computing environment 110 performs real-time analysis and forensic analysis to identify and/or resolve potential security threats that may be affected by applications within the production environment 100. As used herein, real-time analysis includes near real-time analysis and other computations, analysis, and/or operations that occur without delay or within short durations of time from the occurrence of the one or more events or operations, according to one embodiment.

The central asset management computing environment 110 receives notifications of potential security threats against the virtual assets and/or applications within geographic regions, according to one embodiment. In one embodiment, the central asset management computing environment 110 receives a notification of an event that is associated with a potential security threat. In one embodiment, an event is defined in terms of one or more patterns of operational characteristics associated with a virtual asset and or an application operated within a geographic region, e.g., geographic regions 120, 130, 140. For example, an event that indicates a potential security threat can be defined by a pattern of increased user traffic to one instance of an application in one geographic region while the instances of the application in one or more other geographic regions remains relatively unchanged. As another example, an event that indicates a potential security threat is defined by a pattern of receiving multiple non-standard information requests from an application during non-business hours in a time zone of one of the geographic regions 120, 130, 140, according to one embodiment. In other embodiments, an event that indicates a potential security threat is defined in terms of other patterns related to one or more other operational characteristics of the virtual asset or application. According to one embodiment, operational characteristics include, but are not limited to, any communications traffic to/from an application, quantity of communications traffic, content of communications traffic, types of operations executed by the application, types of requests received by the application, time of day, month, or year of requests received by the application, user profiles of systems in communication with the application, frequency of communication traffic with a user profile, and the like.

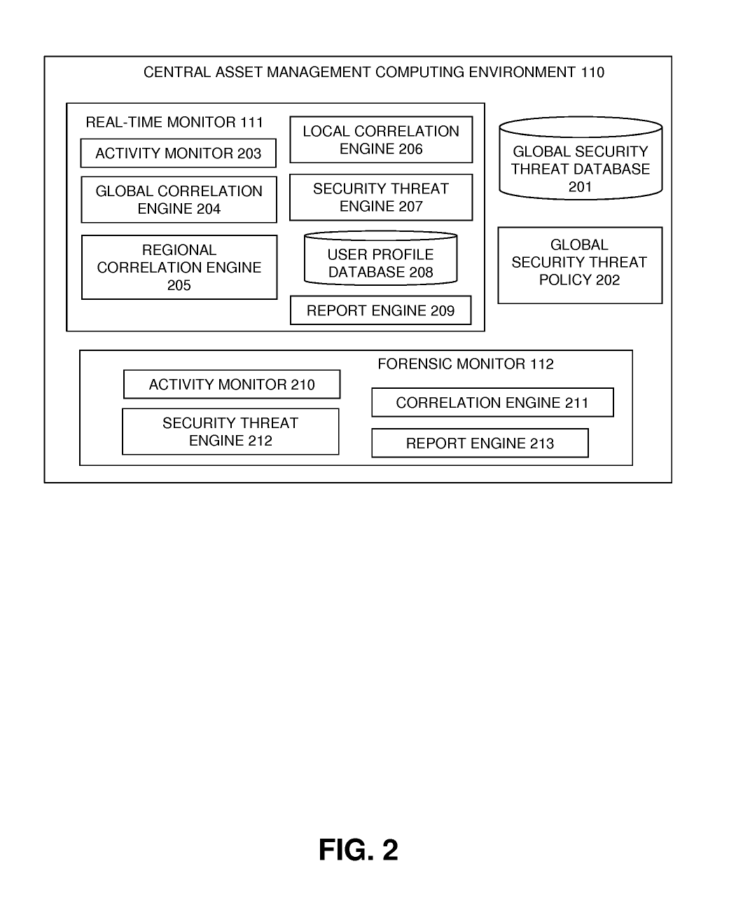

The central asset management computing environment 110 includes a real-time monitor 111 and a forensic monitor 112 for defining, identifying, and/or resolving potential security threats and/or events that indicate the existence of a potential security threat, according to one embodiment. The real-time monitor 111 and forensic monitor 112 can receive information related to the operational characteristics of one or more virtual assets and/or applications within the production environment 100. For example, the regional asset computing environment 122 includes a virtual asset 123 and an application 124, the regional asset computing environment 132 includes a virtual asset 133 and an application 134, and the regional asset computing environment 142 includes a virtual asset 143 and an application 144, according to one embodiment. The real-time monitor 111 and forensic monitor 112 can be configured to receive notifications, summaries, or other information related to the operational characteristics of one or more of the virtual assets 123, 133, 143 and/or of the applications 124, 134, 144, according to one embodiment. According to one embodiment, the real-time monitor 111 receives live information or near real-time information related to the virtual assets 123, 133, 143 or related to the applications 124, 134, 144 to enable the real-time monitor 111 to expedite a determination as to whether the virtual assets or applications are compromised by or are under attack by a potential security threat. In one embodiment, the forensic monitor 112 receives accumulated operational characteristics or other information related to the virtual assets and/or applications, to identify patterns that are indicative of potential security threats and/or to identify resolutions for potential security threats against the virtual assets or applications of the production environment 100. The real-time monitor 111 and the forensic monitor 112 are described in further detail below, in connection with FIG. 2.

According to various embodiments, the central asset management computing environment 110 receives notification of an event from a regional asset management computing environment after a regional asset management computing environment is incapable of resolving an event; after the regional asset management computing environment validates the authenticity of an event; after the regional asset management computing environment determines that an event is of a particular type; or for events that affect a particular type of information (credit card information, social security numbers, financial information, etc.).

In response to receiving notification of an event, the central asset management computing environment 110 proceeds to resolve the event, according to one embodiment. In one embodiment, resolving the event includes reporting one or more patterns, events, and/or potential security threats to one or more security personnel. Security personnel can include, but are not limited to, system administrators, security experts, and/or tenants of the virtual asset that is hosting the application from which the event originated, according to one embodiment.

The central asset management computing environment 110 can also be configured to resolve the event based on the resolution of other potential security threat events, according to one embodiment. The central asset management computing environment 110 maintains a table, database, or other data structure of prior operating characteristics, patterns, events, event causes, and event resolutions. In response to find a previously resolved potential security threat that matches or that is similar to a present event, the central asset management computing environment 110 transmits one or more security updates, software patches, and/or resolution instructions to the regional asset computing environment from which the event was received, according to one embodiment.

The central asset management computing environment 110 allocates computing resources within each region to selectively monitor one or more applications. To efficiently use existing computing resources, the central asset management computing environment 110 allocates computing resources based on the likelihood of attack on an application in a region, according to one embodiment. For example, if the first geographic region 120 includes Asia so that the regional asset computing environment 122 includes a data center located in Asia, the central asset management computing environment 110 may assign computing resources to continuously monitor the operational characteristics of the application 124 and/or of the virtual asset 123. The central asset management computing environment 110 allocates monitoring computing resources to a geographic region based at least partially on the importance of the applications in a geographic region, according to one embodiment. For example, the central asset management computing environment 110 can configure the regional asset management computing environment 121 to continuously or periodically monitor the operational characteristics of the instance of the application 124 if the application 124 is used to store and manipulate financial or personal information for the Heads of State of one or more countries or territories. In another embodiment, the central asset management computing environment 110 figures the regional asset management computing environment 131 to continuously or periodically monitor the applications of the second geographic region 130 based at least partially on traffic characteristics of the geographic region, the number of applications in the geographic region, the history of the geographic region for receiving security threats, the types of applications hosted in the geographic region, tenant requests, initial detections of suspicious (but unverified) activity (logins, command executions, account activity, information requests/transmissions), or the like.

In one embodiment, the central asset management computing environment 110 distributes asset management functions to the regional asset management computing environments associated with the virtual assets or the applications that are monitored for potential security threats. According to one embodiment, the regional asset management computing environment 121 includes a real-time monitor 125 and a forensic monitor 126, the regional asset management computing environment 131 includes a real-time monitor 135 and a forensic monitor 136, and the regional asset management computing environment 141 includes a real-time monitor 145 and a forensic monitor 146. The real-time monitors 125, 135, 145 are configured to perform one or more of the functions of the real-time monitor 111, according to one embodiment. The forensic monitors 126, 136, 146 are configured to perform one or more functions of the forensic monitor 112, according to one embodiment. By decentralizing the functions of the central asset management computing environment 110 into the regional asset management computing environments 121, 131, and 141, the central asset management computing environment 110 can improve the analytic performance of the production environment 100. For example, because the regional asset management computing environment 121, 131, 141 are geographically proximate to the regional asset computing environments 122, 132, 142, distributing the central asset management functions to the regional asset management computing environments 121, 131, 141 reduces latencies associated with transmitting information over multiple networks from one location to another location, according to one embodiment. Another benefit of distributing the central asset management functions to the regional asset management computing environments 121, 131, 141 is a reduction in the amount of traffic that would need to be pushed through a single network connection, according to one embodiment. Another benefit of distributing the central asset management functions to the regional asset management computing environment 121, 131, 141 is that the central asset management computing environment 110 can selectively configure or enable particular ones of the regional asset management computing environments 121, 131, 141 to continuously or periodically monitor the operational characteristics of an application. Concurrently, the central asset management computing environment 110 can configure the other ones of the regional asset management computing environments 121, 131, 141 to not continuously or periodically monitor the operational characteristics of the application, according to one embodiment.

The regional asset management computing environments 121, 131, 141 are configured to correlate operational characteristics of one of the geographic regions 120, 130, 140 with other ones of the geographic regions 120, 130, 140, according to one embodiment. Each of the regional asset management computing environments 121, 131, 141 receives operational characteristics, patterns of operational characteristics, and/or events triggered by the detection of patterns of operational characteristics from corresponding regional asset computing environments 122, 132, 142, according to one embodiment. Because each of the regional asset management computing environments 121, 131, 141 can be configured to function in a similar manner as each of the other regional asset management computing environments 121, 131, 141, the following discussion will be limited to the regional asset management computing environment 121, with the understanding that similar functionality can be implemented into the regional asset management computing environments 131 and 141, according to one embodiment.

The regional asset management computing environment 121 manages one or more regional asset computing environments 122, according to one embodiment. Management of one or more regional asset computing environments 122 can include virtual asset creation, virtual asset deletion, and dynamic resource allocation to existing virtual assets, according to one embodiment. The regional asset management computing environment 121 manages pattern definitions, event definitions, event notification distribution, event monitoring, and inter-regional correlation of changes to operational characteristics instances applications, e.g., the application 124, hosted within the first geographic region 120, according to one embodiment. In one embodiment, the regional asset management computing environment 121 monitors events for regional asset computing environments using inputs, e.g., summaries of operational characteristics of the application 124, received from the regional asset computing environments, e.g., the regional asset computing environment 122. In some embodiments, the regional asset management computing environment 121 receives information related to operational characteristics of the application 124 directly from the application 124 or directly from the virtual asset 123 that hosts the application 124. In another embodiment, the regional asset management computing environment 121 distributes operational characteristic monitoring functions to the virtual asset 123, or to the regional asset computing environment 122 from which the virtual asset 123 is launched or executed.

In one embodiment, the regional asset management computing environment 121 correlates the operational characteristics associated with a defined event with the operational characteristics of another instance/version/copy of the application running in other geographic regions. The regional asset management computing environment 121 correlates the operational characteristics of an application in one region with the operational characteristics of an application in another region to contextualize the operational characteristics that generated the event. For example, if the user traffic to the application 124 in the first geographic region 120 increases/decreases by a predetermined amount, e.g., 30%, while traffic quantities remain relatively unchanged for another instance of the application 124, e.g., the application 144, in the third geographic region 140, the regional asset management computing environment 121 may determine that the increase in user traffic to the application 124 is an event that represents a security breach of the application 124 by a potential security threat, according to one embodiment. Although only three geographic regions 120, 130, 140 are illustrated in FIG. 1, the production environment 100 includes tens, hundreds, or thousands of similar geographic regions with corresponding computing environments, virtual assets, and applications, according to various embodiments. The regional asset management computing environment 121 can be configured to correlate the operational characteristics of the application 124 with all other instances of the application that are operated in all other geographical regions, or the regional asset management computing environment 121 can be configured to correlate the operational characteristics of the application 124 with a select few of the other instances of the application that are operated in other geographical regions, according to one embodiment. For example, the regional asset management computing environment 121 can be configured to correlate the operational characteristics of the application 124 with all other instances of the application 124 hosted within the first geographic region 120, according to one embodiment. According to another embodiment, the regional asset management computing environment 121 can be configured to correlate the operational characteristics of the application 124 with instances of the application that are hosted in one or more adjacent geographic regions, e.g., the second geographic region 130 or the third geographic region 140. In configurations where the production environment 100 includes tens or hundreds of geographic regions, the regional asset management computing environment 121 can be configured to correlate the operational characteristics of the application 124 with other instances of the application that satisfy one or more predetermined criteria. Examples of the one or more predetermined criteria can include, but not be limited to, other instances of the application that are operating in the same time zone, other instances of the application that provide service to the same continent, other instances of the application that do not share the same time zone as the application 124, other instances of the application that are pseudo-randomly selected from a list of all of the other instances of the application, other instances of the application that are operating in relatively high-security threat regions, other instances of the application that are operating in relatively low-security threat regions, and the like.

The regional asset management computing environment 121 defines potential security threats based on suspicious operational characteristics of the application 124, according to one embodiment. For example, the application 124 may be initialized, setup, or configured to provide a computing service to all users located within the first geographic region 120. An example of a suspicious operational characteristic of the application 124 can include the detection of a user account or profile that requests information from the application 124 and forwards the information to an IP address within the third geographic region 140, even though the user account or profile has an IP address within the first geographic region 120. The suspiciousness of such an activity can be elevated if the forwarding IP address within the third geographic region 140 is in a country or territory that has been associated with cyber-attacks, terrorism, or other unlawful or malicious behavior, according to one embodiment. Another example of the suspicious operational characteristics of the application 124 can include the detection of the user account or profile that requests information from the application 124 when the user account or profile is associated with another instance of the application 124, e.g., the application 144, and when the user account profile is associated with an IP address of another geographic region, e.g., the second geographic region 130 or the third geographic region 140. Although the regional asset management computing environment 121 may initially flag extra-regional requests as potentially suspicious, the regional asset management computing environment 121 can be configured to confirm the validity of a user's login credentials, password, account, and/or profile by communicating with other regional asset management computing environments 131, 141, according to one embodiment. In some embodiments, the regional asset management computing environment 121 requests usage history for the user account profile and compares the detected potentially suspicious activities to the user's historic activities. If the user's current inter-regional computing activities are consistent with the user's historic computing activities, then the regional asset management computing environment 121 may determine that the potentially suspicious computing activities do not pose a security threat. If, however, the regional asset management computing environment 121 determines that the computing activities associated with one or more user accounts or profiles poses a potential security threat, the regional asset management computing environment 121 can be configured to temporarily or permanently limit or block access to the application 124 by the particular user account or profile, according to one embodiment. According to another embodiment, if the regional asset management computing environment 121 determines the activities associated with one or more user accounts or profiles poses a potential security threat to the application 124, the regional asset management computing environment 121 can be configured to notify the central asset management computing environment 110, or other computing environments, of the potential security threat to enable the central asset management computing environment 110 to take remedial action, such as to notify the user associated with the user account, suspend account privileges/activities, notify a tenant of the virtual asset 123, and/or notify one or more security personnel of the flag computing activities.

The regional asset computing environment 122 is configured to host the virtual asset 123 that is allocated to one or more tenants for hosting applications, such as the application 124, according to one embodiment. Because each of the regional asset computing environments 122, 132, 142 can be configured to function similar to each of the other regional asset management computing environments 122, 132, 142, the following discussion will be limited to the regional asset computing environment 122, with the understanding that similar functionality can be implemented into the regional asset management computing environments 132 and 142, according to one embodiment. The virtual asset 123 is an allocation of one or more hardware, software, and/or firmware resources to one or more customers or tenants. The tenant may purchase, rent, lease, borrow, or otherwise receive authorization to install, operate, transfer, and/or host applications and/or data with the virtual asset 123, according to one embodiment. The virtual asset 123 includes the application 124, according to one embodiment. In some embodiments, the virtual asset 123 hosts multiple applications, of which the application 124 is one. The application 124 can provide an interface to users and can provide one or more database, computing, or other services to users. The virtual asset 123 monitors operational characteristics of the application 124 to detect one or more patterns of operational characteristics and generates or triggers an event when one or more predetermined patterns of operational characteristics are detected. In response to generating an event, the virtual asset 123 can be configured to notify the regional asset management computing environment 121 and/or the central asset management computing environment 110 of the detected patterns, according to one embodiment. While the applications 124, 134, 144 can be different applications hosted in different geographic regions, according to one embodiment, the applications 124, 134, 144 are all instances, implementations, installations, or copies of the same application that is replicated and hosted in different geographic regions to improve and/or customize the services provided to users or customers within a particular geographic region, according to one embodiment.

Each of the computing environments of the production environment 100 can be communicatively coupled together through the network 150, according to one embodiment. The network 150 can include one or more communication channels 151, 152, 153, 154, 155, 156, and 157 that enable the computing environment to communicate information to one another, according to one embodiment. The network 150 can include, but not be limited to, a LAN, PAN, WAN, intranet, and the Internet, according to various embodiments.

FIG. 2 illustrates a block diagram of an implementation of the central asset management computing environment 110, according to one embodiment. In addition to the real-time monitor 111 and the forensic monitor 112, the central asset management computing environment 110 also includes a global security threat database 201 and a global security threat policy 202, according to one embodiment.

The global security threat database 201 includes information about security threats that enable the central asset management computing environment 110 to identify, detect, and/or resolve potential security threats within the production environment 100, according to one embodiment. The global security threat database 201 includes tables and/or data structures that define potential security threats to the computing environments within the production environment 100. The global security threat database 201 can also include patterns of operational characteristics of applications that correspond with an attack by a potential security threat against a virtual asset, e.g., virtual assets 123, 133, 143, or against an application, e.g., applications 124, 134, 144, according to one embodiment. Examples of patterns of operational characteristics can include sequences of commands or requests sent to an application, digital signatures or digital patterns within the content of payload data in digital communications, types of requests or commands transmitted to an application during particular hours of the day, quantities of requests or commands transmitted to an application, relative changes in communication traffic type or quantity as compared between different instances of the same application that is hosted in different geographic regions, user account or profile characteristics, and the like. The central asset management computing environment 110 can populate the global security threat database 201 using information gained while analyzing and resolving prior security breaches, or by gathering security threat information from one or more third party computing security companies, according to one embodiment.

The global security threat policy 202 defines events and determines actions for computing environments to execute in response to detection of predetermined patterns of operational characteristics, according to one embodiment. The global security threat policy 202 can associate an event with one or more patterns of operational characteristics. Each event is associated with the particular identifier and a level of seriousness, according to one embodiment. For example, the global security threat policy 202 can define an event based on patterns of user account abuse and increased communications traffic to the application 124 as a denial of service attack and, for example, assign a level of six (on a scale of 1 to 10) to the event. The global security threat policy 202 also determines an action for a computing environment to take upon detection of one or more defined events, according to one embodiment. For example, the global security threat policy 202 can include instructions for a virtual asset or regional asset computing environment to notify a regional asset management computing environment or the central asset management computing environment 110 when a defined event has been triggered, according to one embodiment. Upon receipt of notification of the defined event, the central asset management computing environment 110, a regional asset management computing environment, or a regional asset computing environment can block communications from a particular IP address, can temporarily or permanently block service to a user account, can notify a user or security personnel of the event, or can temporarily take an application off-line, according to various embodiments.

The real-time monitor 111 can interface with the global security threat database 201 and the global security threat policy 202 to provide decentralized management of potential security threats within the production environment 100, according to one embodiment. The real-time monitor 111 includes an activity monitor 203, a global correlation engine 204, a regional correlation engine 205, a local correlation engine 206, a security threat engine 207, a user profile database 208, and a report engine 209, according to one embodiment. The activity monitor 203 interfaces with the regional asset management computing environments 121, 131, 141 and/or the regional asset computing environments 122, 132, 142 to receive operational characteristics, patterns of operational characteristics, notification of patterns of operational characteristics, events, and/or notification of events related to one or more of the applications 124, 134, 144, according to one embodiment.

The real-time monitor 111 uses the global correlation engine 204, the regional correlation engine 205, and/or the local correlation engine 206 to correlate detected operational characteristics of an application with historical operational characteristics of the application and/or with the operational characteristics of other instances of the application, according to one embodiment. The global correlation engine 204 can be configured to compare the operational characteristics of one application to the operational characteristics of all of the instances of the application operating or hosted within the production environment 100, according to one embodiment. The regional correlation engine 205 can be configured to compare the operational characteristics of one application to be operational characteristics of one or more other applications that are operating in or hosted in differing geographic regions, according to one embodiment. The local correlation engine 206 can be configured to compare the operational characteristics of one application to the historic operational characteristics of the application and/or to the operational characteristics of other instances of the application that are operating within the same geographic region, e.g., the first geographic region 120, according to one embodiment. By correlating the operational characteristics of an application with the operational characteristics of other instances of the application, the central asset management computing environment 110 can determine that detected changes in the operational characteristics of an application are “normal” at least partially based on detecting similar changes to the operational characteristics of other instances of the application, according to one embodiment.

The real-time monitor 111 uses the security threat engine 207 to resolve and/or temporarily contain the effects of a potential security threat, according to one embodiment. For example, the security threat engine 207 transmits security updates or security patches to the virtual asset or the regional asset computing environment associated with the detected event that is indicative of a potential security threat, according to one embodiment. In other embodiments, the security threat engine 207 compares event notifications to the contents of the global security threat database 201 to determine correlation between the detected operational characteristics of the application and the characteristics of known or recorded security threats, according to one embodiment. The security threat engine 207 uses the contents of event notifications and the contents of the user profile database 208 to verify user account information, to notify a user that a user account has potentially been compromised, and/or to temporarily or permanently disable a potentially compromised user account, according to one embodiment.

The real-time monitor 111 uses the report engine 209 to transmit one or more reports related to potential security threats detected within the production environment 100, according to one embodiment. For example, the report engine 209 can transmit one or more reports to security personnel, to a tenant of a virtual asset, to a user, or the like to expedite the analysis and resolution of potential security threats within the production environment 100, according to one embodiment.

The forensic monitor 112 differs from the real-time monitor 111 in that the forensic monitor 112 is not configured to provide real-time or near real-time analysis and feedback based on operational characteristics of applications detected within the production environment 100, according to one embodiment. The forensic monitor 112 includes activity monitor 210, a correlation engine 211, a security threat engine 212, and a report engine 213, according to one embodiment. The activity monitor 210 requests and/or receives reports from various computing environments within the production environment 100 to perform less time sensitive analyses of operational characteristics of applications, according to one embodiment. The correlation engine 211 performs global, regional, and/or local correlation of operational characteristics of an application between historic operational characteristics and between operational characteristics of different instances of the application operating in different geographic regions within the production environment 100, according to one embodiment. The security threat engine 212 compares received operational characteristics to information in the global security threat database 201 to identify patterns and trends that may correspond with potential security threats, according one embodiment. According to another embodiment, the security threat engine 212 identifies and defines new potential security threats based on the analysis of historic operational characteristics of one or more applications and updates the global security threat policy 202 to include new patterns events and/or actions related to protecting the production environment 100 against potential security threats, according one embodiment. The report engine 213 generates one or more reports of the findings of the forensic monitor 112 and distributes the one or more reports to users, security personnel, and/or tenants, according to various embodiments.

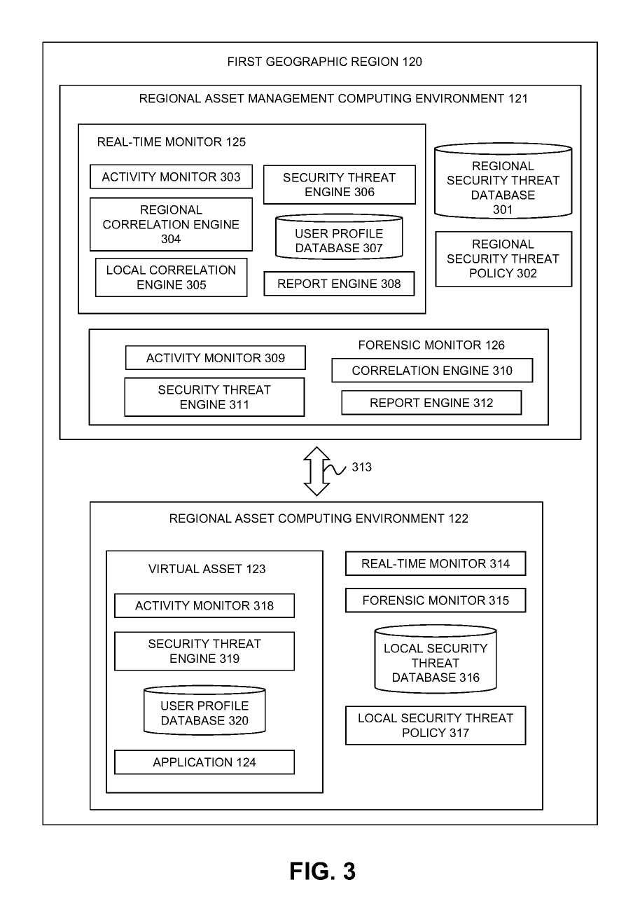

FIG. 3 illustrates a more detailed implementation of the regional asset management computing environment 121 and of the regional asset computing environment 122, according to one embodiment. While FIG. 3 illustrates a detailed implementation of the first geographic region 120, it is to be understood that the second geographic region 130 and the third geographic region 140 can include similar components, modules, engines, databases, and/or functionality, according to one embodiment. The regional asset management computing environment 121 includes a regional security threat database 301 and a regional security threat policy 302, in addition to the real-time monitor 125 and the forensic monitor 126. In one embodiment, the regional security threat database 301 includes all or portions of the global security threat database 201 to enable the regional asset management computing environment 121 to identify, detect, and resolve potential security threats within the production environment 100. The regional security threat policy 302 includes all or portions of the information in the global security threat policy 202, according one embodiment. In another embodiment, the regional security threat policy 302 includes definitions of patterns of operational characteristics, events, and actions for the regional asset management computing environment 121 to apply to one or more of the regional asset computing environments within the first geographic region 120.

The real-time monitor 125 enables the regional asset management computing environment 121 to identify and/or resolve potential security threats for regional asset computing environments within the first geographic region 120, according to one embodiment. The real-time monitor 125 includes an activity monitor 303, a regional correlation engine 304, a local correlation engine 305, a security threat engine 306, a user profile database 307, and a report engine 308, according to one embodiment. In one embodiment, the activity monitor 303, the regional correlation engine 304, the local correlation engine 305, the security threat engine 306, the user profile database 307, and the report engine 308 function in a manner that is similar to the corresponding portions of the real-time monitor 111 of the central asset management computing environment 110. In one embodiment, the difference between the components of the real-time monitor 125 and the real-time monitor 111 is that the components of the real-time monitor 125 are primarily limited in scope to receiving, analyzing, storing, and reporting information associated with regional asset computing environments within the first geographic region 120.

The forensic monitor 126 includes an activity monitor 309, a correlation engine 310, a security threat engine 311, and a report engine 312, according to one embodiment. The activity monitor 309, the correlation engine 310, the security threat engine 311, and the report engine 312 function in a similar manner as the activity monitor 210, the correlation engine 211, the security threat engine 212, and the report engine 213 of the forensic monitor 112, according to one embodiment. The forensic monitor 126 differs from the forensic monitor 112 by monitoring, analyzing, and reporting activities for regional asset computing environments that are within the first geographic region 120, instead of monitoring, analyzing, and reporting activities for regional asset computing environments that are within all of the geographic regions 120, 130, 140, according to one embodiment.

The regional asset computing environment 122 can be configured to communicate with the regional asset management computing environment 121 through a communication channel 313, according to one embodiment. The communication channel 313 may include one or more communication paths that exclude the network 150 and that are not directly accessible from the Internet, according to one embodiment.

The regional asset computing environment 122 allocates one or more hardware, software, and firmware computing resources to one or more virtual assets, e.g., virtual asset 123, to enable a customer or tenant to provide computing services with the application 124, according to one embodiment. The regional asset computing environment 122 includes a real-time monitor 314, a forensic monitor 315, a local security threat database 316, a local security threat policy 317, and the virtual asset 123, according to one embodiment. The real-time monitor 314 can be configured to operate with similar functionality as the real-time monitor 111 and the real-time monitor 125, for the one or more virtual assets operated by or within the regional asset computing environment 122, according to one embodiment. The forensic monitor 315 can be configured to operate with similar functionality as the forensic monitor 112 and the forensic monitor 126, for the one or more virtual assets operated by or within the regional asset computing environment 122, according to one embodiment.

The local security threat database 316 and the local security threat policy 317 identify and define patterns of operational characteristics that represent potential security threats and determine courses of action for the regional asset computing environment 122, the virtual asset 123, and the application 124, upon detection of one or more patterns of operational characteristics that represent potential security threats, according to one embodiment. The local security threat database 316 can include a subset of the regional security threat database 301 and/or a subset of the global security threat database 201 that is relevant for the first geographic region 120 and/or the regional asset computing environment 122, according to one embodiment.

The virtual asset 123 includes an activity monitor 318, a security threat engine 319, a user profile database 320, and the application 124, according to one embodiment. The activity monitor 318 retrieves and stores operational characteristics of the application 124 to enable the virtual asset 123 to selectively analyze the operational characteristics of the application 124 in search of potential security threats, according to one embodiment. The virtual asset 123 uses the activity monitor 318 to establish an average or baseline performance for the operational characteristics of the application 124. The regional asset management computing environment 121 and the central asset management computing environment 110 use the established average or baseline performance of the operational characteristics to determine deviations from historical norms for the application 124 and the other instances of the application 124 that are hosted in the production environment 100. The security threat engine 319 compares the operational characteristics of the application 124 to patterns of operational characteristics stored by the local security threat database 316. Upon detection of one or more of the patterns of operational characteristics, the security threat engine 319 applies the rules defined by the local security threat policy 317 to take appropriate course of action against the potential security threat, according to one embodiment. For example, upon detection of a pattern of operational characteristics that are indicative of a potential security threat, the security threat engine 319 may rely on information in the user profile database 320 to notify a user that a user account for the user may have been compromised, according to one embodiment. In another embodiment, upon detection of a pattern of operational characteristics that are indicative of a potential security threat, the security threat engine 319 may use information from the user profile database 320 to block or delete a user account associated with the detected pattern.

Process

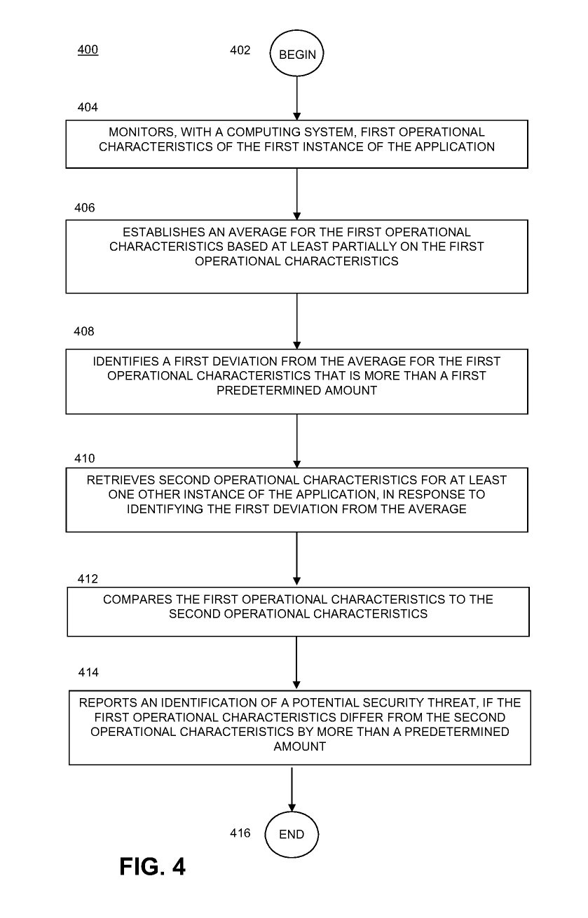

FIG. 4 illustrates a flow diagram of a process 400 for distributing security threat management for virtual assets that are hosted from multiple geographic locations, according to various embodiments.

At block 402, the process begins.

At block 404, the process monitors, with a computing system, first operational characteristics of the first instance of the application, according to one embodiment. The first instance of the application is hosted by a first virtual asset in a first computing environment, and the first computing environment is located in a first geographic region, according to one embodiment. The first operational characteristics include a quantity of communication traffic between the first instance of the application and one or more external computing systems, according to one embodiment.

At block 406, the process establishes an average for the first operational characteristics based at least partially on the first operational characteristics, according to one embodiment.

At block 408, the process identifies a first deviation from the average for the first operational characteristics that is more than a first predetermined amount, according to one embodiment.

At block 410, the process retrieves second operational characteristics for at least one other instance of the application, in response to identifying the first deviation from the average, according to one embodiment. The at least one other instance of the application is hosted by one or more second virtual assets in one or more second computing environments, according to one embodiment. The one or more second computing environments are disposed in one or more second geographic regions that are different than the first geographic region, according to one embodiment.

At block 412, the process compares the first operational characteristics to the second operational characteristics, according to one embodiment.

At block 414, the process reports an identification of a potential security threat, if the first operational characteristics differ from the second operational characteristics by more than a second predetermined amount, according to one embodiment.

At block 416, the process ends.

As noted above, the specific illustrative examples discussed above are but illustrative examples of implementations of embodiments of the method or process for distributing security threat management for virtual assets that are hosted from multiple geographic locations. Those of skill in the art will readily recognize that other implementations and embodiments are possible. Therefore the discussion above should not be construed as a limitation on the claims provided below.

In the discussion above, certain aspects of one embodiment include process steps and/or operations and/or instructions described herein for illustrative purposes in a particular order and/or grouping. However, the particular order and/or grouping shown and discussed herein are illustrative only and not limiting. Those of skill in the art will recognize that other orders and/or grouping of the process steps and/or operations and/or instructions are possible and, in some embodiments, one or more of the process steps and/or operations and/or instructions discussed above can be combined and/or deleted. In addition, portions of one or more of the process steps and/or operations and/or instructions can be re-grouped as portions of one or more other of the process steps and/or operations and/or instructions discussed herein. Consequently, the particular order and/or grouping of the process steps and/or operations and/or instructions discussed herein do not limit the scope of the invention as claimed below.

As discussed in more detail above, using the above embodiments, with little or no modification and/or input, there is considerable flexibility, adaptability, and opportunity for customization to meet the specific needs of various parties under numerous circumstances.

In the discussion above, certain aspects of one embodiment include process steps and/or operations and/or instructions described herein for illustrative purposes in a particular order and/or grouping. However, the particular order and/or grouping shown and discussed herein are illustrative only and not limiting. Those of skill in the art will recognize that other orders and/or grouping of the process steps and/or operations and/or instructions are possible and, in some embodiments, one or more of the process steps and/or operations and/or instructions discussed above can be combined and/or deleted. In addition, portions of one or more of the process steps and/or operations and/or instructions can be re-grouped as portions of one or more other of the process steps and/or operations and/or instructions discussed herein. Consequently, the particular order and/or grouping of the process steps and/or operations and/or instructions discussed herein do not limit the scope of the invention as claimed below.

The present invention has been described in particular detail with respect to specific possible embodiments. Those of skill in the art will appreciate that the invention may be practiced in other embodiments. For example, the nomenclature used for components, capitalization of component designations and terms, the attributes, data structures, or any other programming or structural aspect is not significant, mandatory, or limiting, and the mechanisms that implement the invention or its features can have various different names, formats, or protocols. Further, the system or functionality of the invention may be implemented via various combinations of software and hardware, as described, or entirely in hardware elements. Also, particular divisions of functionality between the various components described herein are merely exemplary, and not mandatory or significant. Consequently, functions performed by a single component may, in other embodiments, be performed by multiple components, and functions performed by multiple components may, in other embodiments, be performed by a single component.

Some portions of the above description present the features of the present invention in terms of algorithms and symbolic representations of operations, or algorithm-like representations, of operations on information/data. These algorithmic or algorithm-like descriptions and representations are the means used by those of skill in the art to most effectively and efficiently convey the substance of their work to others of skill in the art. These operations, while described functionally or logically, are understood to be implemented by computer programs or computing systems. Furthermore, it has also proven convenient at times to refer to these arrangements of operations as steps or modules or by functional names, without loss of generality.

Unless specifically stated otherwise, as would be apparent from the above discussion, it is appreciated that throughout the above description, discussions utilizing terms such as, but not limited to, “activating”, “accessing”, “adding”, “aggregating”, “alerting”, “applying”, “analyzing”, “associating”, “calculating”, “capturing”, “categorizing”, “classifying”, “comparing”, “creating”, “defining”, “detecting”, “determining”, “distributing”, “eliminating”, “encrypting”, “extracting”, “filtering”, “forwarding”, “generating”, “identifying”, “implementing”, “informing”, “monitoring”, “obtaining”, “posting”, “processing”, “providing”, “receiving”, “requesting”, “saving”, “sending”, “storing”, “substituting”, “transferring”, “transforming”, “transmitting”, “using”, etc., refer to the action and process of a computing system or similar electronic device that manipulates and operates on data represented as physical (electronic) quantities within the computing system memories, resisters, caches or other information storage, transmission or display devices.

The present invention also relates to an apparatus or system for performing the operations described herein. This apparatus or system may be specifically constructed for the required purposes, or the apparatus or system can comprise a general purpose system selectively activated or configured/reconfigured by a computer program stored on a computer program product as discussed herein that can be accessed by a computing system or other device.

Those of skill in the art will readily recognize that the algorithms and operations presented herein are not inherently related to any particular computing system, computer architecture, computer or industry standard, or any other specific apparatus. Various general purpose systems may also be used with programs in accordance with the teaching herein, or it may prove more convenient/efficient to construct more specialized apparatuses to perform the required operations described herein. The required structure for a variety of these systems will be apparent to those of skill in the art, along with equivalent variations. In addition, the present invention is not described with reference to any particular programming language and it is appreciated that a variety of programming languages may be used to implement the teachings of the present invention as described herein, and any references to a specific language or languages are provided for illustrative purposes only and for enablement of the contemplated best mode of the invention at the time of filing.

The present invention is well suited to a wide variety of computer network systems operating over numerous topologies. Within this field, the configuration and management of large networks comprise storage devices and computers that are communicatively coupled to similar or dissimilar computers and storage devices over a private network, a LAN, a WAN, a private network, or a public network, such as the Internet.

It should also be noted that the language used in the specification has been principally selected for readability, clarity and instructional purposes, and may not have been selected to delineate or circumscribe the inventive subject matter. Accordingly, the disclosure of the present invention is intended to be illustrative, but not limiting, of the scope of the invention, which is set forth in the claims below.

In addition, the operations shown in the FIG.s, or as discussed herein, are identified using a particular nomenclature for ease of description and understanding, but other nomenclature is often used in the art to identify equivalent operations.

Therefore, numerous variations, whether explicitly provided for by the specification or implied by the specification or not, may be implemented by one of skill in the art in view of this disclosure.

What is claimed is:

1. A computing system implemented method for distributing security threat management of a first instance of an application that is hosted from multiple geographic locations, comprising:
monitoring, with a computing system, first operational characteristics of the first instance of the application,
wherein the first instance of the application is hosted by a first virtual asset in a first computing environment,
wherein the first computing environment is disposed in a first geographic region,
wherein the first operational characteristics include a quantity of communication traffic between the first instance of the application and one or more external computing systems;
establishing an average for the first operational characteristics based at least partially on the first operational characteristics;
identifying a first deviation from the average for the first operational characteristics that is more than a first predetermined amount;
in response to identifying the first deviation from the average, retrieving second operational characteristics for at least one other instance of the application,
wherein the at least one other instance of the application is hosted by one or more second virtual assets in one or more second computing environments,
wherein the one or more second computing environments are disposed in one or more second geographic regions that are different than the first geographic region;
comparing the first operational characteristics to the second operational characteristics; and
reporting an identification of a potential security threat if the first operational characteristics differ from the second operational characteristics by more than a second predetermined amount.

2. The method of claim 1, wherein the second operational characteristics are an average of one or more of the second operational characteristics of the at least one other instance of the application.

3. The method of claim 1, wherein the computing system is a first computing system,
wherein retrieving the second operational characteristics includes:
transmitting a request from the first computing system to the second computing system to receive the second operational characteristics; and
receiving the second operational characteristics from the second computing system,
wherein the second computing system is located in the one or more second geographic regions.

4. The method of claim 1, further comprising:
determining an event that includes one or more patterns of the first operational characteristics; and
reporting the identification of a potential security threat if an event is detected.

5. The method of claim 1, wherein monitoring includes receiving the first operation characteristics from the virtual asset hosting the first instance of the application.

6. The method of claim 1, wherein monitoring the first operational characteristics of the first instance of the application includes monitoring the first operational characteristics in real-time or near real-time.

7. The method of claim 1, further comprising:
comparing the first operational characteristics of the application to multiple patterns of operational characteristics,
wherein each of the multiple patterns of operational characteristics represents one or more potential security threats; and
reporting the identification of the potential security threat if the first operational characteristics match any of the patterns of operational characteristics.

8. The method of claim 7, wherein the multiple patterns of operational characteristics are stored by the computing system in a data structure.

9. The method of claim 1, wherein monitoring the first operational characteristics of the first instance of the application includes monitoring the first operational characteristics because applications hosted in the first geographical region have a higher-than-average likelihood of receiving cyber-attack.

10. The method of claim 1, wherein the first operational characteristics and the one or more second operational characteristics include one or more:
commands received by the first instance of the application from the one or more external computing systems;
requests received by the first instance of the application from the one or more external computing systems;
digital signatures of content of the communication traffic;
IP addresses associated with the one or more external computing systems; and
user accounts for users that have access to the first instance of the application.

11. The method of claim 1, further comprising:
verifying a status of a user account that has submitted a request for information from the first instance of the application, if the user account is associated with an IP address that is located in the one or more second geographic regions.

12. The method of claim 11, wherein verifying the status of the user account includes transmitting a request for account validation to the one or more second virtual assets in the one or more second geographic regions.

13. The method of claim 11, further comprising:
reporting the identification of the potential security threat if the status of the user account is other than active.

14. A computing system implemented method for distributing security threat management of a first instance of an application that is hosted from multiple geographic locations, comprising:
receiving, with a regional management computing system, a security threat policy from a global management computing system,
wherein the security threat policy includes multiple patterns of operational characteristics for the first instance of the application,
wherein each of the multiple patterns of operational characteristics is associated with one or more potential security threats against the first instance of the application;
monitoring, with the regional management computing system, operational characteristics of the first instance of the application,
wherein the first instance of the application is hosted by a first virtual asset in a first computing environment and the first instance of the application is different than at least one other instance of the application that is hosted by at least one other virtual asset in at least one other computing environment,
wherein the first computing environment is located in a first geographic region and the at least one other computing environment is located in at least one other geographic region;
comparing the operational characteristics of the first instance of the application to at least one of the multiple patterns of operational characteristics to detect the one or more potential security threats; and
reporting an identification of the one or more potential security threats if the operational characteristics are similar to at least one of the multiple patterns of operational characteristics.

15. The method of claim 14, wherein the operational characteristics of the first instance of the application are first operational characteristics, the method further comprising:
retrieving second operational characteristics for at least one other instance of the application;
comparing the first operational characteristics to the second operational characteristics; and
reporting the identification of the one or more potential security threats if the first operational characteristics deviate from the second operational characteristics by more than a predetermined amount.

16. The method of claim 14, wherein the operational characteristics of the first instance of the application include one or more:
commands received by the first instance of the application from one or more external computing systems;
requests received by the first instance of the application from the one or more external computing systems;
digital signatures of content of communication traffic between the first instance of the application and the one or more external computing systems;
IP addresses associated with the one or more external computing systems; and
user accounts for users that have access to the first instance of the application.

17. A system for distributing security threat management of a first instance of an application that is hosted from multiple geographic locations, the system comprising:
at least one processor; and
at least one memory coupled to the at least one processor, the at least one memory having stored therein instructions which, when executed by any set of the one or more processors, perform a process for distributing security threat management of a first instance of an application that is hosted from multiple geographic locations, the process including:
monitoring, with a computing system, first operational characteristics of the first instance of the application,
wherein the first instance of the application is hosted by a first virtual asset in a first computing environment,
wherein the first computing environment is disposed in a first geographic region,
wherein the first operational characteristics include a quantity of communication traffic between the first instance of the application and one or more external computing systems;
establishing an average for the first operational characteristics based at least partially on the first operational characteristics;
identifying a first deviation from the average for the first operational characteristics that is more than a first predetermined amount;
in response to identifying the first deviation from the average, retrieving second operational characteristics for at least one other instance of the application,
wherein the at least one other instance of the application is hosted by one or more second virtual assets in one or more second computing environments,
wherein the one or more second computing environments are disposed in one or more second geographic regions that are different than the first geographic region;
comparing the first operational characteristics to the second operational characteristics; and
reporting an identification of a potential security threat if the first operational characteristics differ from the second operational characteristics by more than a second predetermined amount.

18. The system of claim 17, wherein the second operational characteristics are an average of one or more of the second operational characteristics of the at least one other instance of the application.

19. The system of claim 17, wherein the computing system is a first computing system,
wherein retrieving the second operational characteristics includes:
transmitting a request from the first computing system to the second computing system to receive the second operational characteristics; and
receiving the second operational characteristics from the second computing system,
wherein the second computing system is located in the one or more second geographic regions.

20. The system of claim 17, wherein the process further comprises:
determining an event that includes one or more patterns of the first operational characteristics; and
reporting the identification of a potential security threat if an event is detected.

21. The system of claim 17, wherein monitoring includes receiving the first operation characteristics from the virtual asset hosting the first instance of the application.

22. The system of claim 17, wherein monitoring the first operational characteristics of the first instance of the application includes monitoring the first operational characteristics in real-time or near real-time.

23. The system of claim 17, wherein the process further comprises:
comparing the first operational characteristics of the application to multiple patterns of operational characteristics,
wherein each of the multiple patterns of operational characteristics represents one or more potential security threats; and
reporting the identification of the potential security threat if the first operational characteristics match any of the patterns of operational characteristics.

24. The system of claim 23, wherein the multiple patterns of operational characteristics are stored by the computing system in a data structure.

25. The system of claim 17, wherein monitoring the first operational characteristics of the first instance of the application includes monitoring the first operational characteristics because applications hosted in the first geographical region have a higher-than-average likelihood of receiving cyber-attack.

26. The system of claim 17, wherein the first operational characteristics and the one or more second operational characteristics include one or more:
commands received by the first instance of the application from the one or more external computing systems;
requests received by the first instance of the application from the one or more external computing systems;
digital signatures of content of the communication traffic;
IP addresses associated with the one or more external computing systems; and
user accounts for users that have access to the first instance of the application.

27. The system of claim 17, wherein the process further comprises:
verifying a status of a user account that has submitted a request for information from the first instance of the application, if the user account is associated with an IP address that is located in the one or more second geographic regions.

28. The system of claim 27, wherein verifying the status of the user account includes transmitting a request for account validation to the one or more second virtual assets in the one or more second geographic regions.

29. The system of claim 27, wherein the process further comprises:
reporting the identification of the potential security threat if the status of the user account is other than active.

30. A system for distributing security threat management of a first instance of an application that is hosted from multiple geographic locations, comprising:
at least one processor; and
at least one memory coupled to the at least one processor, the at least one memory having stored therein instructions which when executed by any set of the one or more processors, perform a process for distributing security threat management of a first instance of an application that is hosted from multiple geographic locations, the process including:
receiving, with a regional management computing system, a security threat policy from a global management computing system,
wherein the security threat policy includes multiple patterns of operational characteristics for the first instance of the application,
wherein each of the multiple patterns of operational characteristics is associated with one or more potential security threats against the first instance of the application;
monitoring, with the regional management computing system, operational characteristics of the first instance of the application,
wherein the first instance of the application is hosted by a first virtual asset in a first computing environment and the first instance of the application is different than at least one other instance of the application that is hosted by at least one other virtual asset in at least one other computing environment,
wherein the first computing environment is located in a first geographic region and the at least one other computing environment is located in at least one other geographic region;
comparing the operational characteristics of the first instance of the application to at least one of the multiple patterns of operational characteristics to detect the one or more potential security threats; and
reporting an identification of the one or more potential security threats if the operational characteristics are similar to at least one of the multiple patterns of operational characteristics.

31. The system of claim 30, wherein the operational characteristics of the first instance of the application are first operational characteristics, the process further comprising:
retrieving second operational characteristics for at least one other instance of the application;
comparing the first operational characteristics to the second operational characteristics; and
reporting the identification of the one or more potential security threats if the first operational characteristics deviate from the second operational characteristics by more than a predetermined amount.

32. The system of claim 30, wherein the operational characteristics of the first instance of the application include one or more:
commands received by the first instance of the application from one or more external computing systems;
requests received by the first instance of the application from the one or more external computing systems;
digital signatures of content of communication traffic between the first instance of the application and the one or more external computing systems;
IP addresses associated with the one or more external computing systems; and
user accounts for users that have access to the first instance of the application.
